(19) United States
(12) Patent Application Publication
(10) Pub. No.: US 2008/0184703 A1
(43) Pub. Date: Aug. 7, 2008

(54) METHOD FOR REGULATING A HYDROSTATIC DRIVE SYSTEM

(75) Inventors: Gunnar Gerth, Aukrug (DE); Jan Bendixen, Esgrus (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 12/018,472

(22) Filed: Jan. 23, 2008

(30) Foreign Application Priority Data
Jan. 25, 2007 (DE) 102007003800.5-12

(51) Int. Cl. F16D 31/02

(52) U.S. Cl. 60/426

(57) ABSTRACT

The invention relates to a method for regulating a hydrostatic drive system which has at least one pump which is driven by an internal combustion engine and at least one hydraulic motor which is driven by the pump, and comprises the method steps:

determining the volume flow rate flowing through the hydraulic motor;

determining a first adjustment nominal value for the hydraulic motor as a function of the previously determined volume flow rate rate;

determining a second adjustment nominal value by modifying the first adjustment nominal value by a correction value which is determined as a function of the nominal/actual value deviation of the internal combustion engine rotational speed by means of a vehicle-specific characteristic curve which incorporates the different power profiles for traction and overrun operation, respectively, of the internal combustion engine, with the hydraulic motor being adjusted in such a way that a substantially constant pressure level is generated at the maximum power level of the internal combustion engine.

### BACKGROUND OF THE INVENTION

The invention relates to a method for regulating a hydrostatic drive system as per the features of claim 1.

In working and construction machines, hydrostatic travel drives are generally provided, which have an internal combustion engine, typically a diesel engine, at least one pump which is driven by the internal combustion engine and at least one hydraulic motor which is supplied by the pump. Here, the hydraulic motor acts via a step-up gearing or a cardan shaft on the drive axle. The associated travel control actions are often designed to be automotive, that is to say the pivoting-out of the pump takes place as a function of the throttle pedal of the internal combustion engine, and therefore as a function of the rotational speed of the latter. This results in smooth starting and, with a progressive increase in volume flow rate, a rising acceleration of the vehicle. It is therefore possible, in a similar way as in a conventional passenger vehicle, for said vehicle to be controlled via the throttle pedal, which makes the task of the operating personnel of corresponding mobile machines, for example wheel loaders, forklift trucks and agricultural and forestry machines, considerably easier.

The control of the pump merely as a function of the throttle pedal position is generally not sufficient for comfortable operation of the vehicle. It is in fact also necessary for the hydraulic motor to be adjusted corresponding to the different load and driving situations. In particular the power consumption capacity of the pumps is generally a multiple of the nominal power of the internal combustion engine, which necessitates a corresponding power limitation of the hydrostatic drive, which power limitation prevents stalling of the internal combustion engine in load operation and prevents over-revving of the internal combustion engine in overrun operation.

In order to impart an optimum torque to the drive system and to be able to call upon the optimum power of the internal combustion engine under different conditions, such as acceleration, deceleration, travelling up a slope and travelling down a slope, a complex pressure sensor arrangement for constant pressure regulation is conventionally necessary.

Corresponding travel controllers are described in DE 42 26 453 A1 and O+P “Olhydraulik und Pneumatic” [“Oil hydraulics and pneumatics”] 35 (1991) no. 11, pages 836-839.

### SUMMARY OF THE INVENTION

The aim of the present invention is to create a simpler and more cost-effective method for regulating the hydraulic motor adjustment in hydrostatic drive systems.

According to the invention, said aim is achieved by means of a method for regulating a hydrostatic drive system which has a pump which is driven by an internal combustion engine and at least one hydraulic motor which is driven by the pump, and comprises the following method steps: the volume flow rate flowing through the hydraulic motor is determined, and a first adjustment nominal value for the hydraulic motor as a function thereof. A second adjustment nominal value is determined from the first adjustment nominal value by modifying the first adjustment nominal value by a correction value which is determined as a function of the nominal/actual value deviation of the internal combustion engine rotational speed by means of a vehicle-specific characteristic curve which incorporates the different power profile, for traction and overrun operation, respectively, of the internal combustion engine. The adjustment of the hydraulic motor takes place in such a way that a substantially constant pressure level is generated at the maximum power level of the internal combustion engine.

The advantage of the method according to the invention is that the regulation of the hydraulic motor adjustment corresponding to the oil quantity fed by the pump at the same time has associated with it a limit load regulation which, in the event of load, counteracts the rotational speed reduction of the internal combustion engine and, in overrun operation, intensifies the braking action thereof without a delay.

The volume flow rate is preferably determined from the present rotational speed of the hydraulic motor and its suction volume or from the present rotational speed of the pump and its suction volume, with the suction volume being determined from the electrical current with which the respective adjusting device is actuated. Alternatively, the volume flow rate can also be determined by means of a volume flow rate measuring unit which is provided in the line system.

The adjustment of the hydraulic motor preferably takes place by means of an electrically proportional adjusting unit. In another embodiment of the invention, the method can also be applied in the case of a hydraulic follow-up adjustment. This has the advantage that the regulating procedure can be installed in construction, forestry and agricultural machines with different travel controllers without greater interventions into the rest of the driving behaviour.

The second adjustment nominal value serves, after the conversion by means of the current characteristic curve of the hydraulic motor, to adjust the hydraulic motor. It can however also be advantageous to apply yet further corrective steps before the conversion by means of the current characteristic curve. For example, the second adjustment nominal value can be adapted yet further to the torque characteristic of the internal combustion engine. This takes place in that the second adjustment nominal value is modified by a correction value which is determined as a function of the actual value of the internal combustion engine rotational speed by means of a vehicle-specific characteristic curve. This results in a third adjustment nominal value which can on demand also be adapted by means of a vehicle-specific characteristic curve to the respective driving profile. Further features and advantages of the invention can be gathered from the following description of the figures, in which:

### BRIEF DESCRIPTION OF THE DRAWINGS

FIGS. 1A, 1B show the flow diagram of an exemplary embodiment of the flow-regulated hydraulic motor adjustment according to the invention;

FIG. 2 shows the suction volume of the hydraulic motor as a function of the adjusting current;

FIG. 3 shows the first adjustment nominal value w as a function of the volume flow rate Q;

FIG. 4 shows the correction f actor K as a function of the deviation of the nominal/actual rotational speed of the internal combustion engine;

FIG. 5 shows the adaptation of the adjustment nominal value to the driving profile;

FIG. 6 shows the current characteristic curve: adjusting current of the hydraulic motor as a function of the adjustment nominal value;

FIG. 7 shows the correction factor K_{M} as a function of the actual rotational speed of the internal combustion engine; and

FIG. 8 shows the drive system for the flow regulated hydraulic motor adjustment.

### DETAILED DESCRIPTION OF THE PREFERRED EMBODIMENT

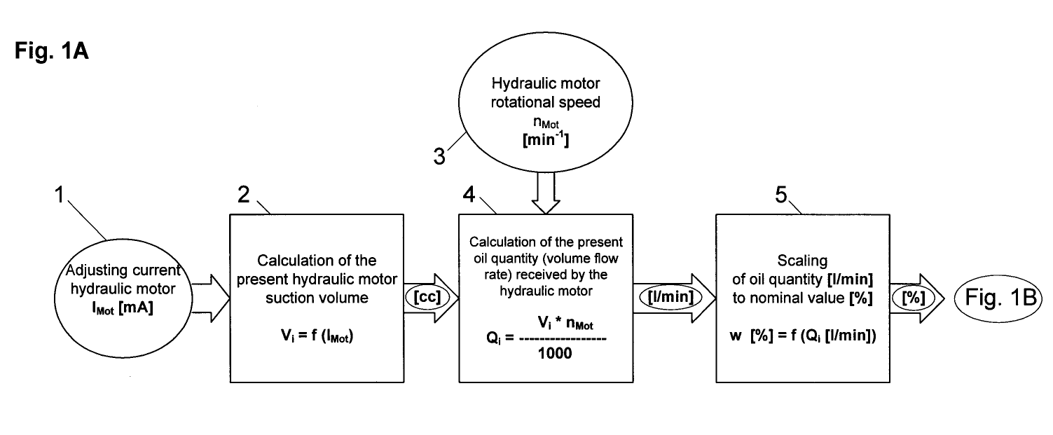

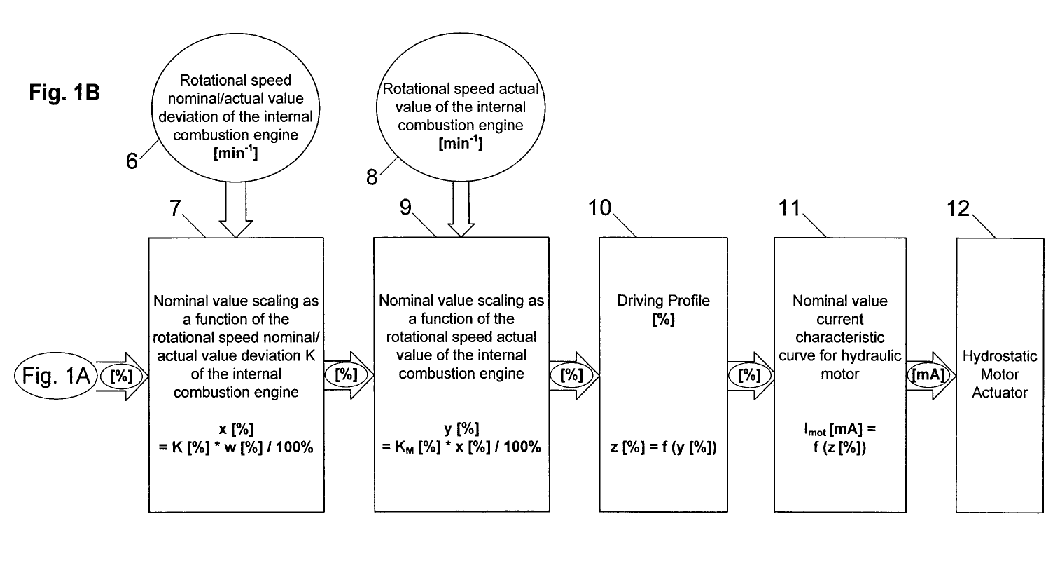

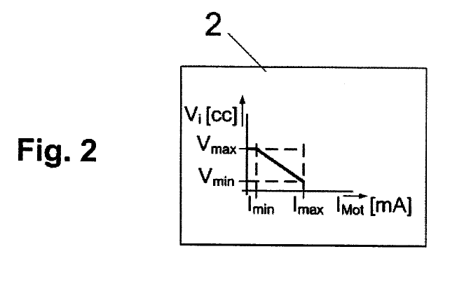

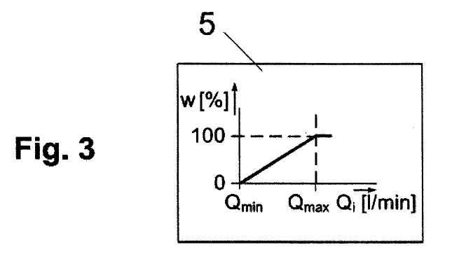

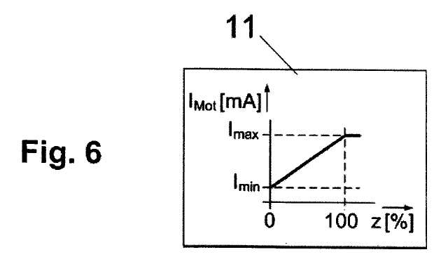

FIGS. 1A and 1B show the flow diagram of an exemplary embodiment of the flow-regulated hydraulic motor adjustment according to the invention. The regulation is based on the determination of the volume flow rate Q, that is to say the oil quantity which is received by the hydraulic motor as per block 4. In the example illustrated, said oil quantity is determined from the rotational speed n_{Mot} and the present suction volume V of the hydraulic motor as per method steps 2, 3. The present suction volume V is in turn given, as per block 1, from the present electrical adjusting current by means of the adjusting current characteristic curve illustrated in FIG. 2. The determined oil quantity Q forms the significant basis for the regulation of the motor adjustment and is converted in block 5 in the course of a simple scaling, as illustrated in FIG. 3, into a first adjustment nominal value w which is specified in percent of the maximum adjustment. This also applies to the further adaptations of the adjustment nominal value which is finally, as illustrated in FIG. 6 (block 11), converted back into electrical current for actuating the hydraulic motor actuator.

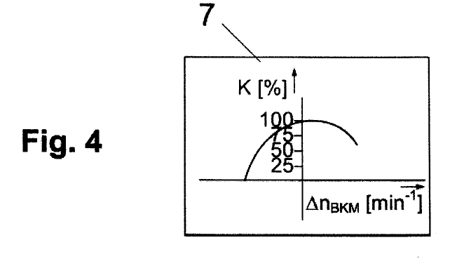

In order to be able to incorporate vehicle-specific characteristics and the different driving situations specified in the introduction, the adjustment nominal value w is modified, as per FIG. 1B (blocks 6, 7), by means of an adjustable characteristic curve. Said characteristic curve is illustrated in FIG. 4 and constitutes a limit load regulation of the internal combustion engine which can be realized in a simple manner. In blocks 6, 7, a correction factor K is determined which is dependent on the deviation Δn_{ICE} of the actual rotational speed from the nominal rotational speed of the internal combustion engine. The nominal rotational speed is given by the position of the throttle pedal/driving potentiometer. The actual value is determined by means of a rotational speed sensor at the shaft of the internal combustion engine. As a function of said actual value, the vehicle-specific profile which is illustrated schematically in FIG. 4 is predefined according to the following criteria: if the nominal value is higher than the actual value, then this means that the internal combustion engine is loaded and is running below normal speed (so-called rotational speed reduction). In the extreme case, the rotational speed reduction would lead to stalling. For this reason, with increasing rotational speed difference, the adjustment nominal value w is increasingly reduced with respect to the profile of the characteristic curve illustrated in FIG. 4. The internal combustion engine is as a result relieved of load and can move back to the nominal rotational speed. In the inverse case, when the nominal rotational speed is lower than the actual value, the internal combustion engine is relieved of load (overrun operation). On account of the associated rotational speed increase, the volume flow rate also increases, which ultimately leads to the loss of the natural braking action of the internal combustion engine. In this case, too, therefore, the adjustment nominal value is increasingly reduced with respect to the characteristic curve in question, which considerably improves the braking action and prevents over-revving of the internal combustion engine.

It is possible in the way shown for the flow-regulated hydraulic motor adjustment to be combined with efficient limit load regulation. The result is the second adjustment nominal value x which is specified in FIG. 1B, block 7 and which is determined from the first adjustment nominal value w and the correction factor K, where x=K*w/100.

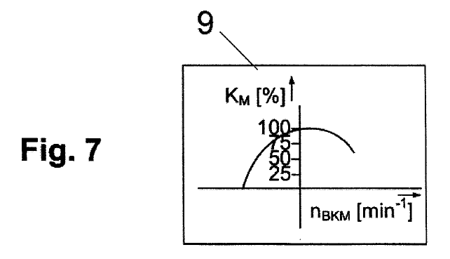

If required, said second adjustment nominal value x can be adapted yet further. Block 9 of FIG. 1B illustrates the adaptation to the characteristic of the internal combustion engine with regard to torque and power. In this regard, FIG. 7 schematically shows an adjustable characteristic curve which can be predefined in a vehicle-specific manner and which shows the correction factor K_{M} as a function of the rotational speed actual value n_{ICE} of the internal combustion engine. Said correction factor K_{M} is profiled correspondingly to the torque/power profile of the internal combustion engine and results, in a similar way to the limit load regulation described above, in a third adjustment nominal value y, where y=K_{M}x/100. It is obtained in this way that the drive always operates close to the optimum power of the internal combustion engine.

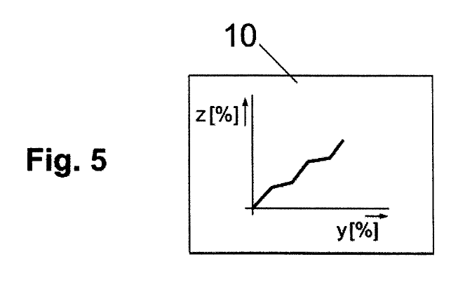

The further method steps illustrated in FIG. 1B in block 10 and block 11 illustrate the conventional adaptation to the driving profile, cf. FIG. 5, and the conversion of the adjustment nominal value into electrical current, cf. FIG. 6, for actuating the hydraulic motor actuator 12. The aggressiveness of the vehicle is set by means of the driving profile, with it for example being possible for accelerations or decelerations to be damped by means of corresponding ramps.

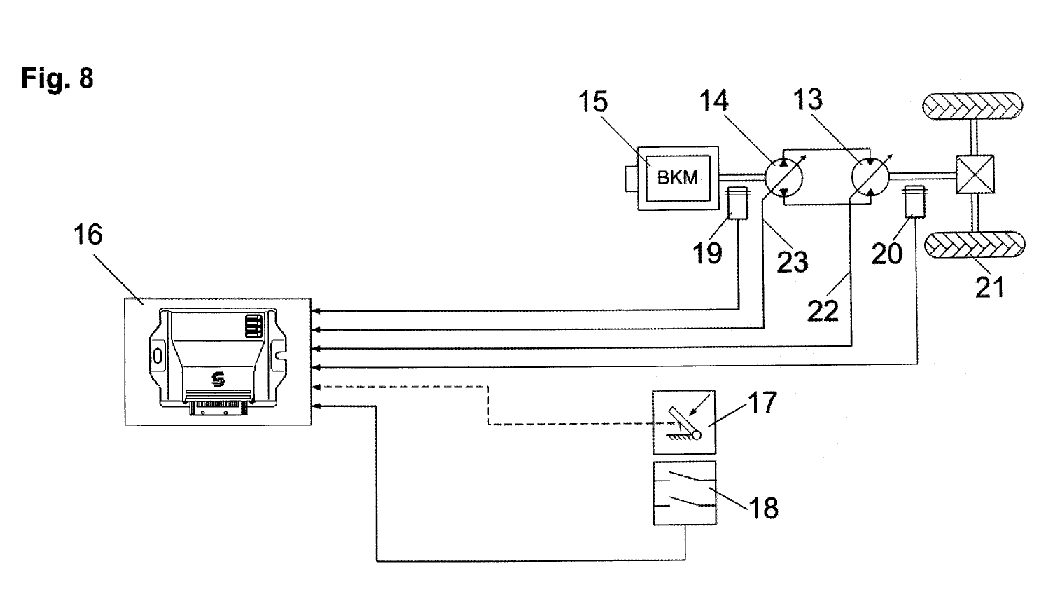

FIG. 8 shows the principle configuration of the drive system for flow-regulated hydraulic motor adjustment. The internal combustion engine (ICE) 15 drives the pump 14 which itself supplies the adjustable hydraulic motor 13. The hydraulic motor drives the drive wheels 21. The driving electronics 16 receive the rotational speeds of the internal combustion engine and of the drive output shaft of the hydraulic motor 13 via the rotational speed sensors 19 and 20, and the signals of the throttle pedal 17 and of the driving direction switch 18. The hydraulic motor actuator is acted on with the electrical adjusting current as per the above-described method via the line 22. The conventional automotive control of the pump 14 takes place via the line 23.

The described exemplary embodiment relates to the electrically proportional adjustment of the hydraulic motor whose actuator is activated with the corresponding electrical signals. The described system can however also be applied to a hydraulic follow-up adjustment. Here, the volume flow rate is determined in a similar way from the adjusting data of the pump which is activated in an electrically proportional manner. The adjustment of the hydraulic motor takes place indirectly by means of the adjusting pressure of the pump. Here, the system is adjusted in such a way that the pump is already adjusted to a maximum extent already at for example approximately half of the adjusting pressure, and by further increasing the pump adjusting current, the adjusting pressure is further increased and the hydraulic motor is therefore adjusted. The hydraulic motor adjustment can be correspondingly configured hydraulically with respect to response pressure and adjusting pressure range.

With the flow-regulated hydraulic motor adjustment 30 according to the invention, a constant pressure level is therefore advantageously obtained at the maximum power level of the internal combustion engine, and a maximum torque is therefore obtained at the output of the hydrostatic travel drive (constant pressure regulation), if, as a result of external loading, the rotational speed of the internal combustion engine is reduced and/or the swash plate of the hydraulic pump is set back to a relatively small angle. In addition, brake pressure control is realized in braking operation, which brake pressure control prevents an undesirably intense deceleration in that, when an actual value which lies above the nominal value of the internal combustion engine rotational speed is detected, the hydraulic motor is pivoted from minimum suction volume to maximum suction volume by means of a different, correspondingly defined characteristic curve or characteristic map.

1. Method for regulating a hydrostatic drive system which has at least one pump (14) which is driven by an internal combustion engine (15) and at least one hydraulic motor (13) which is driven by the pump (14), having the method steps:
determining the volume flow rate (Q) flowing through the hydraulic motor (13);
determining a first adjustment nominal value (w) for the hydraulic motor (13) as a function of the previously determined volume flow rate (Q);
determining a second adjustment nominal value (x) by modifying the first adjustment nominal value (w) by a correction value (K) which is determined as a function of nominal/actual value deviation (Δn_{ICE}) of the internal combustion engine rotational speed by means of a vehicle-specific characteristic curve which incorporates the different power profile, for traction and overrun operation, respectively, of the internal combustion engine (15), and
adjusting the hydraulic motor (13) in such a way that a substantially constant pressure level is generated at the maximum power level of the internal combustion engine.

2. Method according to claim 1, in which method the volume flow rate (Q) is determined from the present rotational speed of the hydraulic motor (13) and its suction volume (V).

3. Method according to claim 1, in which method the volume flow rate (Q) is determined from the present rotational speed of the pump (24) and its suction volume (V).

4. Method according to claim 2, in which method the suction volume (V) is determined from the electrical current with which the adjusting device is actuated.

5. Method according to claim 1, in which method the volume flow rate (Q) is determined by means of a volume flow rate measuring unit which is provided in the line system.

6. Method according to claim 1, in which method the adjustment of the hydraulic motor (13) takes place by means of a hydraulically proportional adjustment.

7. Method according to claim 1, in which method the adjustment of the hydraulic motor (13) takes place by means of an electrically proportional adjusting unit.

8. Method according Method according to claim 1, in which method a third adjustment nominal value (y) is determined from the second adjustment nominal value (x) by modifying the second adjustment nominal value (x) by a correction value (K_{M}) which is determined as a function of the actual value of the internal combustion engine rotational speed by means of a vehicle-specific characteristic curve.

9. Method according to claim 8, in which method the third adjustment nominal value (y) is adapted to the driving profile (z).
